(19) United States
(12) Patent Application Publication
(10) Pub. No.: US 2018/0262859 A1
(43) Pub. Date: Sep. 13, 2018

(54) METHOD FOR SOUND REPRODUCTION IN REFLECTION ENVIRONMENTS, IN PARTICULAR IN LISTENING ROOMS

(71) Applicant: Saalakustik.de GmbH, Isernhagen (DE)

(72) Inventor: Gernot von SCHULTZENDORFF, Giesen (DE)

(21) Appl. No.: 15/738,408

(22) PCT Filed: Jun. 24, 2016
(86) PCT No.: PCT/EP2016/001088

§ 371 Date: May 16, 2018

(30) Foreign Application Priority Data
Jun. 24, 2015 (DE) 10 2015 008 000.8

(51) Int. Cl. H04S 7/00; H04R 27/00

(52) U.S. Cl. CPC H04S 7/305; H04R 2227/007; H04S 2420/01; H04R 27/00

(57) ABSTRACT

Method in which, primarily in listening rooms, instead of the particular environment's own spatial sound, the spatial sound of a third room may be given an enveloping quality in the perception of the listener. The third room spatial acoustics perceived instead of the listening room spatial acoustics act in the same way in terms of hearing physiology as the spatial acoustics of natural rooms. That is, enveloping in terms of the spatial sound (in a distinction from direct sound). This type of spatial enveloping effect may also be incorporated emotionally by the listener into the auditory event, and has no “sweet spot” problem (there is a large preferred listening area instead of a preferred listening spot) and allows low frequencies to act in such a way that use of subwoofer speakers may generally be dispensed with.

The invention relates to a method for sound reproduction in reflective environments, in particular in listening rooms. A number of methods for sound reproduction in listening rooms are known from the prior art, in particular playback via a speaker (mono), via two speakers (stereo), or via four or more speakers, wherein two front and two rear speakers with a center speaker and an optional subwoofer with surround sound reproduction have become established in the market (so-called 5.1 surround sound reproduction configuration). With the objective of enhancing the spatial listening experience in particular in the home audio sector, methods with additional speakers, sometimes also placed at the top of the listening room and oriented toward the listening position, have become increasingly prevalent in recent years, and numerous additional speakers are used in technologically advanced movie theaters.

Great advances have been made in particular in the area of spatial perception, which is based on the localization of sound sources from various directions (direct sound-based); in many cases, a significant improvement may be achieved here by simply increasing the number of speakers placed around the listener. In contrast, the perception in particular of diffuse spatial sound is subject to far fewer mechanisms of localization; in theory, diffuse sound is even ideally described as completely directionless. For the perception of diffuse spatial sound using the methods corresponding to the current technical state of the art, in particular in the home audio sector, specifically targeting human hearing to the localization of sound events from the rear and the side (“flight reflex”) has proven to be problematic due to the fact that even slightly pulse-like sound events emanating from speakers placed in these directions resemble direct sound, and thus in the context of diffuse sound are perceived as objectionable. One possible, frequent consequence is an overall weak spatial effect on many surround recordings and broadcasts, and in other cases the spatial effect is increased using a psychoacoustic means which ultimately has an unnatural effect, or exaggerated expansions of the sound or even direct sound effects are used to intensify the three-dimensional effect. The current methods, in particular for the playback of music whose effect in many cases is closely related to its embedding in three-dimensional space, have been found to have only limited suitability, with the exception of slower, more sustained, less impulsive music in particular spatial environments.

In addition, the surround playback methods corresponding to the current art have the basic disadvantage of a very small preferred listening spot (so-called “sweet spot”). Although this problem in the playback situation of movie theaters may be significantly reduced by the use of additional speakers that are controlled with appropriate delays, such an option generally does not exist in the home audio sector, so that the listener must accept a much less satisfactory spatial effect directly next to the ideal listening spot. In addition, the spatial effect, in particular with regard to the diffuse sound, generally has much less of an enveloping quality, and thus also produces a less emotionally moving response than in good natural room environments without playback systems (good concert halls, for example).

One might suppose that for the current surround sound reproduction, at least the problem of insufficiently enveloping the listener with diffuse sound, and thus, inadequately embedding the listener in the sound event, could be addressed by more intense excitation of the diffuse sound in the listening room, for example by orienting the existing speakers less directly and more indirectly toward the listener, or by using additional speakers for this purpose. Although such measures result in the desired stronger three-dimensional effect, three dimensionality achieved in this way is also perceived as very nonspecific, since the spatial sound information that it contains corresponds to the usually small dimensions of the listening rooms (living rooms, for example), and when used to a greater extent, not only impairs the actually desired perception of the spatial sound information of the recording room (concert hall, for example) contained in the replayed audio, but at a certain point even makes it impossible. In particular, this type of replayed sound is perceived as distorted (Literature: Andreas Rotter, “Wahrnehmbarkeit klanglicher Unterschiede von Hochtonlautsprechern unterschiedlicher Wirkprinzipien” [Perceivability of tonal differences from tweeter speakers having different operating principles], MA TU Berlin 2010, pages 22ff). Certain speaker manufacturers purposely employ comparable methods in the market, including use of omnidirectional speakers, for example. Other types of speakers that are occasionally used are bipole and dipole speakers, in which there is a greater emphasis on avoiding the emission of direct sound in the direction of the listener than the excitation of diffuse sound in the listening room. Besides the problems described above, such apparatuses provide the reproduced audio material, and in particular the relationship between direct and spatial sound, much differently than intended by the producers, so that their use is limited primarily to listeners who feel that the tonal style of most recordings and broadcasts is generally too overpowering.

In particular with regard to a natural and enveloping auditory impression (three-dimensionality), the sound reproduction configurations known from the prior art and described above are thus not capable of achieving good or at least satisfactory results.

This also applies for the methods disclosed in WO 2012/033950 A1 and WO 2013/111034 A2, which attempt to eliminate the above-described problems, in particular to provide improved diffuse sound playback.

WO 2012/033950 A1 discloses in particular a method for replaying multichannel audio, in which transmitted or recorded “dry” audio tracks or “stems” are encoded with time-variable metadata that control a desired degree of diffusivity in the replay of audio signals. Audio tracks are compressed and transmitted in conjunction with synchronized metadata that represent diffusivity, and preferably also mix and delay parameters. The separation of audio stems from diffusivity metadata (solely in the context of transmission of unreverberated audio data) allows subsequent adaptation of the three-dimensional effect, and also facilitates the personal setting of the replay by the listener (customizing). However, the method essentially utilizes the known surround sound reproduction methods, and also does not attempt to overcome the above-described fundamental problems of the current surround sound reproduction systems.

U.S. Pat. No. 7,706,543 B2 discloses a method for processing audio files, in which (a) signals are encoded which represent at least one sound that is propagated in three-dimensional space and derived from a source located at a first distance from a reference point, in order to obtain a representation of the sound through components expressed in a spherical harmonic base having an origin corresponding to this reference point, and (b) applying compensation of a nearfield effect to these components by filtering that is a function of a second distance which, when the sound is replayed by a playback device, essentially defines a distance between a playback point and a point of auditory perception. Spatial compensation by audio sources and a specification of the three-dimensional audio representation of these sources are achieved in this way. The cited document relates to encoding of virtual audio sources as well as acoustic encoding of a natural audio field during a sound recording by one or more three-dimensional networks of microphones.

WO 2013/111034 A2 discloses in particular an audio playback system comprising a first speaker arrangement that delivers audio signals to a listening position, the audio signals taking predominantly a directional path to the listening position, and a second speaker arrangement that delivers audio signals predominantly on a reflected acoustic path to the listening position. An audio material supplier (audio renderer) has an upmixer for upmixing a channel signal of a multichannel audio signal to a first audio signal, and a second audio signal corresponding to more diffuse sound than the first audio signal. The upmixing is in response to a correlation measure for two channels of the multichannel signal. The correlation measure is generated by a correlation estimator. Thus, in this system, in addition to the actual audio signals, diffuse sound that is computed from the audio signal itself is nondirectionally emitted toward the listening position, in order to obtain any type of impression of improved envelopment, and thus, a satisfactory spatial effect. The method thus employs a modified procedure compared to the use of omnidirectional or bipole or dipole speakers, in that only nondirectionally oriented speakers are additionally used, and diffuse audio material is used for their control. However, with this method the above-described problem also occurs that in numerous cases, and primarily during the replay of music, the excited diffuse sound of the listening room does not match the replayed audio, and for this reason the balance of the relationship between direct and spatial sound tends to be adversely affected.

The object of the present invention, therefore, is to significantly reduce or preferably eliminate the disadvantage described above.

In particular, the object of the present invention is to provide a method for sound reproduction in reflective environments, in particular in listening rooms, which is perceived as emotionally engaging.

At the same time, the aim is to achieve a uniformly good spatial effect at all listening spots, at least in the area encompassed by the speakers of the first speaker arrangement. It is absolutely essential to avoid the disadvantage that has occurred thus far in the perception of the listener upon intense excitation of diffuse sound in the listening room, namely, in particular indistinctness, lack of clarity, and distortion of the sound due to disadvantageous superimposition of three-dimensionality on the audio signals.

In the area of live acoustics, the audio signals generally originate from natural sound sources in the reflective environments, i.e., in the listening rooms themselves, in which a number of different scenarios and problems are conceivable. In some concert halls or in some multifunctional halls used as concert halls (with an orchestra, for example, acting as the sound source in such cases), the acoustics are perceived as problematic or unsatisfactory. It would be desirable for the spatial acoustics in such halls to correspond to those of a hall with good acoustics. In situations with amplification, such as in the performance of musicals, the sound is frequently perceived as lacking sufficient three dimensionality, in particular due to the use of strongly directionally emitting line array speakers. Although the emitted signals are reverberated, this sound resonance is perceived as coming only from the front, and not as enveloping.

The use of reverberation time extension systems or also acoustic enhancement systems (AESs) is not perceived as satisfactory in many cases. Such systems operate with a large number of speakers in the room, generally 100 to 300 speakers, and in a few cases merely approximately 50 speakers. Most of these systems are based on the regeneration principle, in which the reverberation present in the room in question is enhanced (MCR, VRAS, for example). In addition, in the systems that operate according to the inline principle (synthetic generation of reverberation), the speakers are aimed essentially directionally at the listener (Vivace, for example). Although the measurable objective of extending the reverberation time is reliably achieved, the ambient sound produced by such systems is perceived as too flat, and often also too loud. Such systems are also increasingly used as a supplement for PA systems in order to achieve a sound effect that is spatially perceived as enveloping. Here as well, the three-dimensionality is frequently perceived as unnatural and flat. In conference rooms, architectural acoustic measures encompassing the use of absorbent materials are often carried out in order to improve the intelligibility of speech. In many cases, even though this objective is achieved, the resulting acoustics are felt to be constricted. Regardless of whether acoustical amplification is used in the rooms, significantly more open acoustics would be desirable, but cannot be achieved with means known thus far (reverberation, for example) without adversely affecting the intelligibility of speech. In many cases the acoustics are also unsatisfactory in the described sense in meeting rooms, salesrooms, and living rooms, but are accepted out of habit. In all the described cases, an improvement of the acoustic situation would be desirable.

The stated objects are achieved according to the invention by a method according to claim 1, a computer program product according to claim 15, a data medium according to claim 16, a device according to claim 17, a system according to claim 18, and use according to claim 19.

In the method according to the invention for sound reproduction in reflective environments, in particular listening rooms, audio signals in playback situations are emitted essentially directionally, in relation to a listening position, from a first speaker arrangement, and the audio signals and spatial sound signals that are originally independent of the listening room are emitted essentially nondirectionally, in relation to a listening position, via a second speaker arrangement, wherein the spatial sound information of the spatial sound signals has an origin that is independent of the audio signals. In live situations,
either spatial sound signals that are independent of the listening room
or spatial sound signals that are independent of the listening room and the audio signals corresponding to live signals
   are emitted essentially nondirectionally, in relation to a listening position, via the second speaker arrangement, wherein the spatial sound information of the spatial sound signals has an origin that is independent of the audio signals corresponding to the live signals.

Within the meaning according to the invention, “wherein the spatial sound information of the spatial sound signals has an origin that is independent of the audio signals” is understood to mean that the three-dimensionality information (i.e., signal components corresponding to reflections and diffuse sound) of the spatial sound signals is not taken from the audio signals or computed from them, but, rather, is supplied to the spatial sound signals by convolution with pulse responses that contain this specific spatial sound information or, as another example, in appropriately configured HOA sound field beams that are used as spatial sound signals. Spatial sound information that is contained in the spatial sound and emitted from suitable speakers in the listening room may evoke in the listener the enveloping perception of three-dimensionality, and preferably the perception of a specific three-dimensionality, i.e., the three-dimensionality of a certain space. The method according to the invention makes use of the fact that human perception incorporates spatial sound information that is felt to be suitable into the perception, but is able to block out other spatial sound information.

Within the meaning of the invention, a listening position is a position which in playback situations corresponds to the traditional listening position in the center of the speakers of a 5.1 surround system, and which in live situations corresponds to the position of a good “listening spot” (in the central area of the room).

While for numerous surround playback methods, in particular in the home audio sector, this listening position is equivalent to the best listening spot, and listening spots at locations other than this specific listening position provide a much poorer listening experience, for clarification of the terms it is pointed out that in the method according to the invention there is no such relationship between the listening position within the meaning according to the invention and an acoustically preferred listening spot, and even listening spots at a considerable distance from the listening position provide a listening experience that is just as good as that at the listening position.

Within the meaning according to the invention, directional emission is understood to mean emission in which the predominant sound component in relation to the listening position is emitted directly or essentially directly to this listening position (with typical deviations of the direct orientation of up to 30 [degrees]).

Within the meaning according to the invention, the first speaker arrangement may generally be suitable for replaying so-called surround audio mixtures without using additional speakers, and is typically also used for this purpose. At least for the first speaker arrangement, one speaker in front and two speakers in the rear or in the rear/at the side are used, while the maximum number of speakers for the first speaker arrangement is unlimited. One arrangement having many speakers, known to those skilled in the art, is the 22.2 configuration by NHK. In particular in movie theaters, additional speakers on the side walls and on the ceiling are being increasingly used in particular for the reproduction of effects in which the intended objective is for the listener to locate the position of effects in the sense of localization. Speaker arrangements in which the described position location and localization are sometimes implemented by reflection of speaker signals on the ceiling or walls are also to be considered as first speaker arrangements within the meaning according to the invention.

Within the meaning according to the invention, the audio signals are generally sound signals, which are transmitted or replayed from a recording, in the form of original microphone recordings or artificially generated signals that are suitable for replay via the described first speaker arrangement, and/or that originate from certain processing operations or mixtures.

These or comparable audio signals, in a suitable mixture if necessary, as well as spatial sound signals that are independent of the listening room are nondirectionally emitted in the direction of the listening position via a second speaker arrangement.

Within the meaning of the invention, spatial sound signals are signals which generally and preferably contain no direct sound components, and whose represented three-dimensionality is not to be associated with the actual listening room, but instead originates from some other space, for example and preferably from a concert hall which is particularly appropriate for the music material in question, and which may be identical to a recording room in which the audio signals have been recorded. According to the invention, the spatial sound signals are preferably present in a form or are generated in such a way that makes it possible to adapt in particular parameters regarding the three-dimensional effect to the particular listening room acoustics.

Although the audio signals generally also already contain spatial sound components (which are overwritten during the convolution for generating the spatial sound signals from the spatial sound information of the pulse responses), they are not present in a form that allows the spatial effect according to the invention, described in greater detail below, to be achieved by replay via the second speaker arrangement. Not only do these spatial sound components often lack uniformity, since in orchestral recordings, for example, they are recorded from multiple differently positioned spot microphones, but in addition, the reverberation carried out with algorithmically operating sound resonance apparatuses in the vast majority of recordings has proven to be largely unsuitable for use in the second speaker arrangement of the method according to the invention.

In particular, the spatial sound components contained in the audio signals cannot be separated from the direct sound signals that are likewise contained in the audio signals, and in addition cannot be altered in a way that would be necessary for adaptation according to the invention to the conditions of the listening room. The emission of audio signals via the second speaker arrangement is an operation which takes place independently of the emission of the spatial sound signals, and which is also controlled independently of same; it is used essentially for the sufficient excitation of diffuse sound in the listening room, which, as proven in practice, is necessary for the perception of enveloping, diffuse three-dimensional effects.

It follows from the above discussion that the spatial sound signals emitted via the second speaker arrangement, and the audio signals likewise emitted via same, are complementary; i.e., they not only supplement one another, but are also mutually dependent. In interaction, on the one hand with a sufficient diffuse sound level the audio signals allow the perception of being enveloped per se, which must necessarily be specified by the information, concerning the characteristics of being enveloped (for example, the spatial impression of a given concert hall), contained in the spatial sound signals. On the other hand, the spatial sound signals allow, instead of a perception of the listening room spatial acoustics, the perception of the desired spatial acoustics, which in turn would have no effect without the envelopment created by the audio signals. The spatial sound signals are generally (but without limitation) generated by convolution or folding of third room pulse responses (the third room, for example and in particular, is a concert hall that is desirable in terms of aesthetics (see above); the third room may correspond to a real model, or may have any desired configuration, for example with the use of suitable simulation software) using the audio signals, which may also be used to carry out the mentioned adaptations to the conditions of the particular listening room.

In this regard, explicit reference is made to the fundamental differences in the described procedure according to the invention from the procedure of the method described above and disclosed in WO 2012/033950 A1, namely, on the one hand the different way of generating spatial sound signals (algorithmic reverberation generation in WO 2012/033950 A1 in contrast to the preferred use of convolution and pulse responses in the method according to the invention), and on the other hand and of particular importance, the fundamentally different nature of the audio signals at the input of the audio renderer; namely, in WO 2012/033950 A1 only “dry” audio tracks or “stems” are used, i.e., signals that are referred to as “unreverberated” by those skilled in the art, which when replayed without this reverberation would be perceived by the listener as unnaturally “dry.” In this regard, a replay via an apparatus corresponding to WO 2012/033950 A1 has a different basis, namely, an essentially “drier” mixture than a replay via the surround replay apparatuses that have been customary thus far, while the method according to the invention may be employed for existing surround replay apparatuses and also used for replaying mixtures via the surround replay apparatuses customary thus far, so that this may be referred to here as “compatibility,” a term commonly used by those skilled in the art, as the result of which the creation and separate transmission of base mixtures of varying reverberation for the various playback apparatuses, as in the method corresponding to WO 2012/033950 A1, is unnecessary in many cases.

Within the context of the invention, nondirectional emission is understood to mean that, in contrast to the directional emission of the predominant sound component, emission does not take place in the direction of the listening position directly, but instead takes place indirectly, so that these sound components are reflected one or multiple times on walls and ceilings and sometimes via the floor until they ultimately arrive at the listening position, and thus as a whole represent a diffuse sound due to the multiple reflections. Within the meaning of the method according to the invention, for nondirectional emission it is essential that a diffuse sound is generated which corresponds to the diffuse sound that is generated in the described manner (with reflections).

It is expressly pointed out that with regard to emission of the spatial sound signals via the second speaker arrangement, this results in diffuse scattering of signals which already represent diffusivity, wherein the diffusivity of the mentioned diffuse scattering contains in itself the features of the listening room (listening room-induced), while the diffusivity represented by the spatial sound signals, as described above, is that of a different space (third room-induced), and in this regard, according to the invention this latter-mentioned diffusivity superposes with the listening room-induced diffusivity in the listening room.

Within the context of the invention, one particular feature of this listening room-induced diffusivity, which according to the invention thus relates to all signals emitted via the second speaker arrangement, the audio signals, as well as the spatial sound signals, is their actual diffusivity, i.e., their real distribution in the listening room, which in principle is different from the diffusivity of the spatial sound signals, which is only represented and only simulated, as a part of audio signals that are perceived, for example, by the listener when emitted via the first speaker arrangement. Within the context of the method according to WO 2012/033950 A1, diffusivity is specifically understood to mean this latter mentioned indirect form of spatial effect, as stated in the following citation: “a diffuse signal or a perceptually diffuse signal in the context of the invention refers to a (usually multichannel) audio signal that has been processed electronically or digitally to create the effect of a diffuse sound when reproduced to a listener.”

Due to the localization effects brought about by the directional orientation of the speakers to the listener, which have no similarity to acoustic diffusivity, and due to the likewise comparatively low diffuse distribution of the sound signals in question in the listening room, likewise caused by the directional orientation of the speakers, such simulated diffusivity results in a much weaker, nonenveloping form of spatial effect that is only indirect, in a manner of speaking. However, in the method according to the invention, the real scattering in the listening room, in conjunction with the origin of the spatial sound information of the spatial sound signals, which is independent of the audio signals, in the perception of the listener also imparts the third room-induced diffusivity with the important features of actual diffusivity that comes from very different directions. As has been found in practice, emission of spatial sound signals solely via the second speaker arrangement would in many cases create a spatial impression that was either too weak, or, at a higher level, too reverberant. Due to the additional emission of audio signals via the second speaker arrangement, it is possible to adapt the diffusivity in the listening room, which is controllable independently of the spatial sound signals, to the extent necessary to produce the described auditory impression.

This first variant of the method according to the invention involves strictly audio replay in a listening room, while in a second variant of the method according to the invention involving live signals in the listening room, spatial sound signals that are independent of the listening room are essentially nondirectionally emitted in the direction of the listening position via the second speaker arrangement, to which the description provided essentially within the context of the first variant likewise applies. Within the context according to the invention, live signals are understood to mean signals that originate from the listening room, for example and in particular in an opera house or a concert hall or some other room during a live performance. Thus, this involves an acoustic enhancement of the listening experience from a spatial standpoint, as in the first variant, whereas in the second variant, the listening room is also the space in which the original sound events take place live. In the second variant, it may be provided on the one hand to use only one speaker arrangement, and within the meaning of the invention to then use the second speaker arrangement of the first variant. In this way, in a manner comparable to the first variant, the spatial sound signals created from live signals by recording them with microphones and third room pulse responses are nondirectionally emitted with respect to the listener, without a direct sound component; the emission of audio signals formed from live signals is possible in the same way as in the first variant, but in particular in many concert halls is not necessary, since in these cases sufficient diffuse sound is already formed in the room. On the other hand, it is also conceivable that in the second variant, the first speaker arrangement emits the live signals in the direction of the listening position essentially directionally, which then involves the use of PA systems for musical performances, for example. It is expressly pointed out that this second variant is also suitable for use in fairly small rooms, and that here as well, a combination with PA system purposes, such as in conference rooms, is possible. In addition, in some cases an apparatus that is installed for the purposes of the first variant may be supplemented with microphones and also used for the purposes of the second variant.

Due to the feature combination, specific in each case, of the two variants of the method according to the invention for sound reproduction in listening rooms, it is surprisingly possible for the first time to transfer an enveloping spatial sound experience of a third room, which is comparable to the listening experience in natural rooms from a psychoacoustic and physiological auditory standpoint, into a listening room in that, in addition to the essentially directional emission of audio or live signals, the listening room itself is acted on by spatial sound signals of a desired space, for example and in particular a concert hall, in combination with the audio or live signals, in terms of a nondirectional emission that is achieved at the listening position. As the result of being able to significantly intensify the spatial sound of the particular listening room (if necessary to produce a sufficient diffuse sound level), and at the same time to mask same in the perception of the listener, the conventional audio or live signal emitted via the first speaker arrangement may be enhanced, from an aesthetic standpoint, with the desired third room spatial acoustics, which, the same as rescattered diffuse sound in the listening room due to the specific processing and emission methods, allows the above-mentioned masking of the listening room spatial acoustics, resulting in a spatial impression, desired in aesthetic terms, which is not present in the actual audio or live signal, or at least does not come into effect in the desired (enveloping) manner, and which does not adversely affect the perception and localization of the direct sound sources contained in the actual audio or live signal. The method according to the invention results from this totally unexpected finding. It is thus possible to achieve replay of audio data that envelops and emotionally engages the listener. At the same time, the listening experience is perceived to be satisfactory in particular in acoustical spatial terms not just at the described listening position; rather, the preferred acoustic range is extended to the entire area between the speakers of the first speaker arrangement (solution to the so-called “sweet spot” problem), which in addition likewise surprisingly results in an excellent bass response, even without a subwoofer—on its own, in a manner of speaking.

Within the context of the invention, it is advantageous, as proven in practice, that regarding the second speaker arrangement the sound levels of the audio signals are to be set in comparison to the sound level of the spatial sound signals, and the sound levels of both mentioned signals are set to be in comparison to the sound level of the audio signals of the first speaker arrangement and/or the live signals, in such a way that on the one hand, sufficient excitation of the listening room with diffuse sound from a physiological auditory standpoint takes place as such, and on the other hand, the effect of the third room spatial sound signals is perceived as appropriate. In different configurations, not least as a function of the particular program material, setting very different level ratios may be necessary here. For example, the enveloping spatial sound representation of a large concert hall in a small living room requires a high sound level of the audio signals in the second speaker arrangement. Even with a much lower level of the third room spatial sound signals in relation to the level of the audio signals, the desired, described effect may be adapted to the listener, which results from carrying out the method according to the invention. Unlike most surround audio playback systems as the first speaker arrangement, which are directionally directed toward the listener, in a live situation in an acoustically problematic concert hall the orchestra also radiates a considerable portion of its sound to the ceiling and the walls of the concert hall, so that, depending on the concert hall, a much lower quantity of audio signals, corresponding to the live signals, in the second speaker arrangement is necessary for generating diffuse sound than in the home audio living room, or also sufficient diffuse sound is already present in the hall, so that spatial sound signals are then emitted solely via the second speaker arrangement.

Furthermore, in this context it is advantageous, as proven in practice (but without limitation), that the spatial sound signals are third room pulse responses that professionals in the field are able to produce with standard equipment, in the recording room or in other suitable rooms, or to create same from real rooms or from virtual spaces with standard simulation software, which in some cases are also available in a suitable manner and quality from the particular desired rooms and surroundings, or concert halls and opera houses around the world (as offered by Audioease, for example).

Future, in particular sound field-based methods of audio recording and transmission will open up different and/or further options for creating spatial sound signals. One example is recordings produced according to the higher order Ambisonics (HOA) method, for example using the Eigenmike microphone array from mh acoustics. Such audio material, which likewise meets the requirements of the method according to the invention, provides, instead of premixed audio channels, a sound field or multiple sound fields recorded at a certain location in the recording room, from which variable excerpts, for example spatial sound signals largely without a direct sound component, may be subsequently selected with regard to direction and directional characteristics, using so-called beams. The audio signals may also be taken from this sound field, which allows further, even more differentiated procedures within the scope of the method according to the invention.

Within the meaning of the method according to the invention, a “sound field” is all acoustic information (direct sound, reflections, and diffuse sound in succession with time intervals/delays) that is perceived at a certain location in the room; the sound field is thus the excerpt of all sounds in the room, relating to this location, that is generated by live and/or speaker signals in the room. Important parameters of the acoustic information are its particular level (in the case of diffuse sound, the reverberation curve that represents the variation of the level over time) and the direction from which the information is perceived (with accuracy that decreases from direct sound to diffuse sound). In many cases, the perception of the sound field takes place as a whole, in that, together with the direct sound, an associated three-dimensionality (and not individual echoes, for example) is perceived.

In order to achieve an even more satisfactory auditory impression (expanded breadth of the sound and an even more enveloping spatial impression), it is advantageous, as shown in practice, when early reflection signals (specific selected and set spatial sound signals) are emitted, via the second or a third speaker arrangement (this third speaker arrangement for example and in particular having at least two speakers for lateral sound signals and/or one speaker for early reflection signals coming from above), in the direction of the listening room walls and/or the listening room ceiling in such a way that the early reflection signals are reflected on the listening room walls (front-side, approximately at ear level or higher in relation to the listening position) and/or on the listening room ceiling (upper front center) essentially in the direction of the desired acoustic range.

Moreover, in individual applications it may be advantageous that the second speaker arrangement is configured in such a way that the audio signals and/or the live signals, and the spatial sound signals are emitted via separate speaker chassis.

In addition, it is advantageous when the second speaker arrangement at least and preferably has the following speakers: a speaker for nondirectional emission from the upper left front in relation to the listening position, a speaker for nondirectional emission from the upper right front in relation to the listening position, a speaker for nondirectional emission from the upper left rear in relation to the listening position, and a speaker for nondirectional emission from the upper right rear in relation to the listening position. Accordingly, the speakers do not necessarily have to be placed in the area of the stated position, and instead may be placed in a manner and at a position that ensures perception of the diffuse sound from the described direction. Although diffuse sound is not perceived as directionless (as in theoretical acoustics), it is still perceived as sound with a much lower degree of directivity than direct sound (for this reason, the HOA ambient components in the future MPEG-H 3D audio standard are typically transmitted at a lower Ambisonic order than for the predominant components). Perception from four areas above the head of the listener with the subdivisions left/right and front/rear is to be regarded as advantageous from the standpoint of the method according to the invention, and it is likewise advantageous when the nondirectional emission, to the greatest extent possible, results in multiple reflections, for example on the ceiling and on the walls.

Use of a much larger number of speakers within the scope of the second speaker arrangement is not very advantageous in conjunction with the method according to the invention. Superimpositions of diffusivities occur which can no longer be differentiated from a physiological auditory standpoint, so that a diffuse sound with reverberatory properties is perceivable, but not other spatial sound characteristics. The reverberatory properties of so-called reverberation time extension systems or acoustic enhancement systems referred to above as “flat” may be explained by the use of an (excessively) large number of speakers. Within the context of the invention, not only the use of preferably four speakers for the second speaker arrangement, but also the control of these speakers with specifically processed and thus, also different spatial sound signals is not insignificant. In the production of pulse responses that are used for the particular speakers, measurement positions or orientations in the third room (whose design may differ greatly from that of the listening room) are generally and preferably selected that result in a balanced replay in the listening room that is preferably advantageously representative of the acoustics of the third room in the listening room replay context. As shown in practice, it is generally advantageous when the areas of the measurement positions or measurement orientations in the third room (for example, in relation to a good listening spot in the concert hall or in relation to a realistic listening spot in a film scene) correspond in principle (in particular with regard to front/rear) to the areas of emission of the convolution products to be associated via the second speaker arrangement in the listening room (in relation to the listening position). As a variant that has proven suitable in practice, in large, high rooms (in concert halls, for example) it is also possible in many cases for spatial sound signals which are is configured for four speakers, for example, to be combined on the left and right sides and emitted via only two speakers.

In addition, it is advantageous when the speakers of the second speaker arrangement are controlled in a time-delayed manner or early in comparison to the audio signals of the first speaker arrangement or the live signals in order to provide a further option for acoustic shaping.

For this reason, it is also advantageous when the speakers of the third speaker arrangement are controlled in a time-delayed manner or early in comparison to the audio signals of the first speaker arrangement or the live signals.

In practice, setting such a delay is part of an artistic so-called upmix, in which the spatial acoustics represented by the spatial sound signals are adapted to the new environment by fine adjustment.

The audio signals are typically present in channel-based form for replay via the first speaker arrangement. In an artistic upmix, for purposes of replay via the second speaker arrangement, these audio signals, as described above, on the one hand are mixed (audio signal component), and on the other hand are convolved with third room pulse responses (spatial sound signal component). As mentioned above, an adaptation of the spatial sound signals to the particular acoustic situation of the listening room is made in the convolution. As a result of the spatial sound signals, relating to the signal path in front of the apparatus associated with the method according to the invention, not being present or transmitted in channel-based audio form, but instead being generated in each case in the apparatus, preferably by convolution, for the same audio signals, in each case adapted spatial sound signals may be generated, and adapted mixtures for controlling the second speaker arrangement may be made, for different listening rooms by adapted changes in suitable convolution parameters (for example, reverberation length, size of the room, spatial breadth, delays).

In practice, audio signals and pulse responses are thus necessary for replaying audio corresponding to a preferred form of the method according to the invention. As mentioned, preferably surround mixtures, among others, that are already provided for replay via the first speaker arrangement (also without use of a second speaker arrangement) are suitable as audio signals. For operations involving the pulse responses, it is advantageous when they are exchanged and distributed in this form, which makes their direct use (i.e., without adapting parameters) possible, provided that the spatial acoustic properties of the particular listening room correspond to a standard room whose specifications match those which the people using these audio signals in conjunction with the mentioned pulse responses for replay via the method via the method according to the invention have agreed upon.

The spatial acoustic properties of the listening room are preferably determined in a measuring procedure based on measuring operations, known per se, that are available in particular for more high-quality surround playback systems and carried out prior to initial operation of the apparatus. In addition to manual inputs by the user concerning the room dimensions and placement of the speakers, not only suitable levels, delays, and frequency response corrections, but also spatial acoustic parameters such as the reverberation time in particular are determined by means of a measuring microphone, and sounds and signals emitted via the speakers.

If the spatial acoustic properties of the listening room used deviate from the mentioned standard room, an adaptation of the convolution and mix parameters is made, corresponding to the particular deviations. These parameters may also be used for achieving a three-dimensional effect (so-called customizing) that meets the tastes of the listener.

In addition, it is advantageous for the overall sound when no direct sound components are contained in the spatial sound signals, primarily since the direct sound components, if not carefully adapted, may disadvantageously interfere with the audio signals.

Additional advantageous sound design options open up the following possibilities:
changing the control time of the front speakers of the second speaker arrangement in relation to the listening position, with respect to the rear speakers of the second speaker arrangement in relation to the listening position, by controlling these speakers earlier or later,
carrying out multiple emissions of the audio signals at different points in time within the second speaker arrangement, and
carrying out the emission of at least portions of the audio signals via the second speaker arrangement in both a delayed and an undelayed manner with respect to at least portions of the audio signals that are emitted via the first speaker arrangement.

Within the context according to the invention, it is advantageous when the speakers of the second speaker arrangement are generally controlled in pairs or groups (viewed crosswise to the listening position) by associated pairs or groups of the first speaker arrangement.

Moreover, it is advantageous when the audio signals of pairs and/or groups of speakers of the first speaker arrangement are generally replayed in an undelayed manner or with a slight delay via generally the nearest pair or the nearest group of speakers of the second speaker arrangement.

Furthermore, it is advantageous, as shown in practice, that the masking of the listening room-induced spatial sound information may be greatly improved in the perception of the listener when audio signals that are emitted via a pair or via a group of speakers of the second speaker arrangement are additionally replayed via further pairs or groups of speakers of the second speaker arrangement, generally with an additional slight delay that is positively correlated with the distance between the particular pairs and/or groups of speakers, and at a slightly lower level with increasing distance.

Also claimed according to the invention are a computer program that is configured for carrying out the method according to the invention, a computer program product that is configured for carrying out the method according to the invention, a data medium containing a computer program according to the invention or a computer program product according to the invention, a device that is configured for carrying out the method according to the invention, and a system that is configured for carrying out the method according to the invention.

Also claimed is the use of the method according to the invention and/or of the computer program according to the invention and/or of the computer program product according to the invention and/or of the data medium according to the invention and/or of the device according to the invention and/or of the system according to the invention and/or of audio signals that are nondirectionally emitted in relation to a listening position, and/or of live signals that are nondirectionally emitted and at the same time spatial sound signals that are nondirectionally emitted, independently of a listening room, in relation to a listening position, and whose spatial sound information has an origin that is independent of the audio signals, for evoking, from a physiological auditory standpoint, the perception of three-dimensionality by the listener, produced by the spatial sound signals, concurrently with at least substantial acoustic masking of the diffuse sound of the listening room.

The invention is explained in greater detail below by way of example, without being limited thereto, wherein

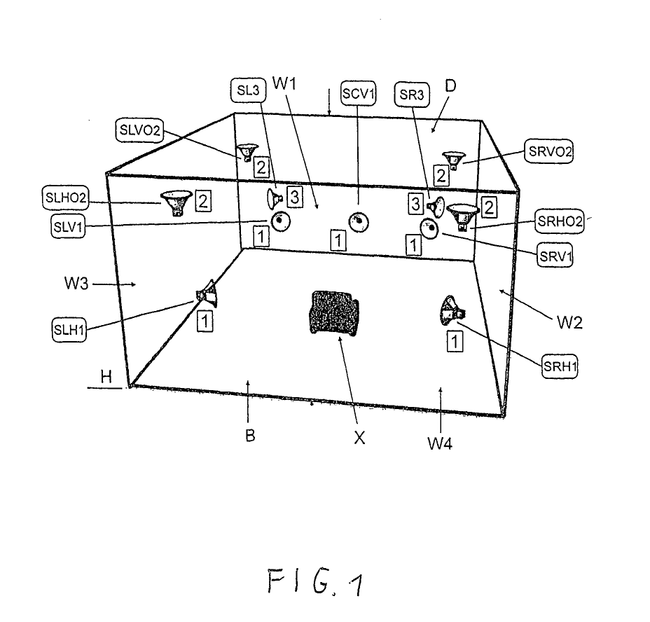

FIG. 1 shows a perspective, schematic illustration of one possible embodiment of the method according to the invention.

FIG. 1 illustrates a perspective, schematic view of one possible speaker configuration within a listening room H, the listening position itself being denoted by reference character X, and the listener looking at a wall W1.

During a sound replay in a listening room H, audio signals, for example fed from hi-fi components, are emitted essentially directionally from a first speaker arrangement made up of the speakers SLV1, SCV1, SRV1, SLH1, and SRH1, in the direction of the listening position X, this configuration corresponding to a traditional 5.1 surround speaker configuration without a subwoofer. The audio signals are thus transmitted essentially directionally to the listener at the listening position X. These audio signals correspond to the sound information originating from conventional recording technology, i.e., channel-based, not sound field-based.

At the same time, the audio signals, and the spatial sound signals which are independent from the listening room H and whose spatial sound information has an origin independent of the audio signals, are emitted essentially nondirectionally, namely, essentially in the direction of the listening room ceiling D in relation to the listening position X, via a second speaker arrangement made up of the speakers SLVO2, SRVO2, SLHO2, and SRHO2, the spatial sound signals and the audio signals exerting complementary effects on the three-dimensional perception.

Appropriately adjusting the level of the audio signals with respect to the spatial sound signals within the second speaker arrangement and also in relation to the sound level of the audio signals of the first speaker arrangement results in a natural musical sound that is perceived as realistic, wherein the audio signals emitted via the second speaker arrangement increase the diffusivity in the listening room to an extent that the perception of enveloping three dimensionality according to the invention is made possible for the first time, and wherein the spatial sound signals emitted via the second speaker arrangement not only mask the listening room-induced three-dimensionality information of the diffuse sound of the listening room H in the listener's perception, but in particular also ensure the perception of three-dimensionality, corresponding to the spatial sound information of the spatial sound signals, in an enveloping manner.

For subjectively expanding the breadth of the sound and for enhancing the spatial sound enveloping effect, a third speaker arrangement made up of the speakers SL3 and SR3 is installed in the listening room H. Early reflection signals (specific selected and set spatial sound signals) are emitted via the speakers SL3 and SR3 in such a way that they are reflected on the listening room walls W2 and W3 essentially in the direction of the listening position X. The acoustic impression of a realistic space is further intensified by this measure.

In another variant in which, instead of a sound replay in the listening room H, it is not audio signals that are used, but, rather, live signals, for example during a live performance in opera houses or concerts, either spatial sound signals that are independent of the listening room H, or spatial sound signals that are independent of the listening room and audio signals corresponding to the live signals, are essentially nondirectionally emitted in the direction of the listening position X via the second speaker arrangement, wherein the spatial sound signals on one side, and either the component of the live signals that produces the diffuse sound, or the component of the live signals that produces the live signals and the audio signals corresponding to the live signals on the other side, exert complementary effects on the three-dimensional perception. In this configuration, the speakers SLV1, SCV1, SRV1, SLH1, and SRH1 are generally not actively operated, but under some circumstances, also with omission of the use of rear speakers, may be actively operated, in particular for PA system purposes, for example during musical performances.

However, in the acoustic masking of the listening room-induced spatial sound signals of the listening room H during live performances, in any case the speakers SLVO2, SRVO2, SLHO2, and SRHO2 are controlled. If necessary, the speakers of the third speaker arrangement, namely, SL3 and SR3, are also controlled.

It is thus possible to optimize unfavorable spatial acoustics of the listening room H in which the live event takes place by masking the listening room acoustics, in that in the perception of the listener, the listening room acoustics are replaced by desired spatial acoustics of a third room contained in the mentioned spatial sound signals.

### LITERATURE CITATIONS

WO 2012/033950 A1
WO 2013/111034 A2
Ben Kok: Acoustic Enhancement System, Production Partner April 2011, pp. 108-117
J. Herre, J. Hilpert, A. Kuntz, J. Plogsties: MPEG-H Audio—The Upcoming Standard for Universal Spatial/3D Audio Coding, Proceedings of ICSA 2014, Erlangen, ISBN 978-3-98 12830-4-4, p. 54
Andreas Rotter: Wahrnehmbarkeit klanglicher Unterschiede von Hochtonlautsprechern unterschiedlicher Wirkprinzipien [Perceivability of tonal differences from tweeter speakers having different operating principles], MA TU Berlin 2010, pp. 22ff.

1-19. (canceled)

20. A method for sound reproduction in a listening room having at least one speaker arrangement of a group made up of a first speaker arrangement and a second speaker arrangement, the method comprising:
a.) in playback situations, aa.) audio signals from a first speaker arrangement are emitted essentially directionally in relation to a listening position, wherein ab.) the audio signals and spatial sound signals that are originally independent of the listening room and that contain the spatial sound information of one or more real or virtual spaces are emitted essentially nondirectionally in relation to the listening position via a second speaker arrangement, and the spatial sound information of the spatial sound signals has an origin that is independent of the audio signals; or
b.) in live situations, ba.) live signals are emitted into the room, and bb.) either bba.) spatial sound signals that are independent of the listening room and that contain the spatial sound information of one or more real or virtual spaces, or bbb.) spatial sound signals that are independent of the listening room and that contain the spatial sound information of one or more real or virtual spaces, and audio signals corresponding to the live signals are emitted essentially nondirectionally in relation to the listening position via the second speaker arrangement, and the spatial sound information of the spatial sound signals has an origin that is independent of the audio signals corresponding to the live signals; or
b.) in live situations, either ca.) spatial sound signals that are independent of the listening room and that contain the spatial sound information of a real or a virtual space of real or virtual rooms, or cb.) spatial sound signals that are independent of the listening room and that contain the spatial sound information of a real or a virtual space of real or virtual rooms, and audio signals corresponding to the live signals are emitted essentially nondirectionally in relation to the listening position via the second speaker arrangement, and spatial sound information of the spatial sound signals has an origin that is independent of the audio signals corresponding to the live signals; or
d.) in playback situations, da.) audio signals from a first speaker arrangement are emitted essentially directionally in relation to a listening position, wherein db.) the audio signals and spatial sound signals that are originally independent of the listening room are emitted essentially nondirectionally in relation to the listening position via a second speaker arrangement, and characterized in that spatial sound information of the spatial sound signals has an origin that is independent of the audio signals; or
e.) in live situations, ea.) live signals are emitted into the room and eb.) either eba.) spatial sound signals that are independent of the listening room or ebb.) spatial sound signals that are independent of the listening room and audio signals corresponding to the live signals are emitted essentially nondirectionally in relation to the listening position via the second speaker arrangement, and the spatial sound information of the spatial sound signals has an origin that is independent of the audio signals corresponding to the live signals, or
f.) in live situations, either fa.) spatial sound signals that are independent of the listening room and that contain the spatial sound information of a real or a virtual space of real or virtual rooms, or fb.) spatial sound signals that are independent of the listening room and that contain the spatial sound information of a real or a virtual space of real or virtual rooms, and audio signals corresponding to the live signals are emitted essentially nondirectionally in relation to the listening position via the second speaker arrangement, and spatial sound information of the spatial sound signals has an origin that is independent of the audio signals corresponding to the live signals.

21. The method according to claim 20, wherein:
a) the spatial sound signals are convolution products of third room pulse responses.

22. The method according to claim 20, wherein:
a) early reflection signals or medium-early reflection signals originating from the spatial sound signals are emitted in the direction of the listening room walls and/or the listening room ceiling via the second speaker arrangement in such a way that the early reflection signals or medium-early reflection signals reflected on the listening room walls and/or on the listening room ceiling are reflected essentially in the direction of the listening position; or
b.) early reflection signals or medium-early reflection signals originating from the spatial sound signals are emitted in the direction of the listening room walls and/or the listening room ceiling via a third speaker arrangement in such a way that the early reflection signals or medium-early reflection signals reflected on the listening room walls and/or on the listening room ceiling are reflected essentially in the direction of the listening position.

23. The method according to claim 20, wherein the second speaker arrangement is configured in such a way that
a) the audio signals and the spatial sound signals are emitted via separate speaker chassis; or
b) the audio signals corresponding to the live signals, and the spatial sound signals are emitted via separate speaker chassis; or
c) the spatial sound signals in relation to the audio signals and in relation to the audio signals corresponding to the live signals are emitted via separate speaker chassis.

24. The method according to claim 20, wherein the second speaker arrangement has at least the following speakers:
a)—a speaker for nondirectional emission from the upper left in relation to the listening position,
a speaker for nondirectional emission from the upper right in relation to the listening position, or
b)—a speaker for nondirectional emission from the upper left front in relation to the listening position,
a speaker for nondirectional emission from the upper right front in relation to the listening position,
a speaker for nondirectional emission from the upper left rear in relation to the listening position,
a speaker for nondirectional emission from the upper right rear in relation to the listening position.

25. The method according to claim 24, wherein:
a) the third speaker arrangement has at least the following speakers:
a speaker for reflective emission from the left front at ear level or higher in relation to the listening position, and a speaker for reflective emission from the right front at ear level or higher in relation to the listening position, and/or
a speaker for reflective emission from the upper front center in relation to the listening position.

26. The method according to claim 24, wherein:
a) the speakers of the second speaker arrangement of the third speaker arrangement are controlled with specifically processed, and accordingly different, spatial sound signals.

27. The method according to claim 20, wherein:
a) the speakers of the second speaker arrangement are controlled in a time-delayed manner or early in comparison to the live signals or the audio signals of the first speaker arrangement.

28. The method according to claim 22, wherein:
a) the speakers of the third speaker arrangement are controlled in a time-delayed manner or early in comparison to the live signals or the audio signals of the first speaker arrangement.

29. The method according to claim 20, wherein:
a) the front speakers of the second speaker arrangement in relation to the listening position are controlled early or in a time-delayed manner in comparison to the rear speakers of the second speaker arrangement in relation to the listening position.

30. The method according to claim 20, wherein:
a) the audio signals are emitted multiple times at different points in time within the second speaker arrangement.

31. The method according to claim 20, wherein:
a) at least portions of the audio signals are emitted via the second speaker arrangement in both a delayed and an undelayed manner with respect to at least portions of the audio signals of the first speaker arrangement.

32. The method according to claim 20, wherein:
a) portions of the audio signals are emitted via the front speakers of the second speaker arrangement in relation to the listening position earlier than the same portions of the audio signals via the rear speakers in relation to the listening position, or conversely.

33. The method according to claim 20, wherein:
a) the audio and spatial sound signals within the second speaker arrangement are independently controllable with regard to their sound level.

34. A computer program product that is configured for carrying out the method according to claim 20.

35. A data medium containing a computer program that is configured for carrying out the method according to claim 20.

36. A device that is configured for carrying out the method according to claim 20.

37. A system that is configured for carrying out the method according to claim 20.

38. Use of one of:
a) the method according to claim 20; or
b) the computer program product according to claim 34; or
c) the data medium according to claim 35; or
d) the device according to claim 36; or
e) the system according to claim 37 for evoking, from a physiological auditory standpoint, the enveloping perception of three-dimensionality represented by the spatial sound signals, concurrently with at least substantial acoustic masking of the three-dimensional effect of the listening room.
